(19) United States
(12) Patent Application Publication
(10) Pub. No.: US 2015/0120731 A1
(43) Pub. Date: Apr. 30, 2015

(54) PREFERENCE BASED CLUSTERING

(71) Applicants: PHILIPPE NEMERY, Shanghai (CN); Mengjiao Wang, Shanghai (CN)

(72) Inventors: PHILIPPE NEMERY, Shanghai (CN); Mengjiao Wang, Shanghai (CN)

(21) Appl. No.: 14/072,794

(22) Filed: Nov. 6, 2013

(30) Foreign Application Priority Data
Oct. 30, 2013 (CN) 201310524920.9

(51) Int. Cl. G06F 17/30

(52) U.S. Cl. CPC G06F 17/30598
USPC 707/737

(57) ABSTRACT

To cluster objects associated with a dataset, a selection of criteria is received. For the received criteria, preference information is received to perform a preference-based clustering of the objects. Based on the preference information, a uni-criterion preference degree corresponding to each of the selected criterion is computed. The uni-criterion preference degrees of all the selected criteria are aggregated to compute a universal preference degree. Based on a preference-type and the computed preference degree, a relationship matrix is generated. The matrix representing similarity measure between the objects is generated. The objects are clustered according to the relationship matrix. A visualization of the clustered objects is rendered on an associated user interface.

### BACKGROUND

A cluster may represent a gathering of various elements based on common factors corresponding to the elements. Various methods can be adopted to categorize or group these elements into corresponding clusters. Clustering methods based on intrinsic characteristics of the elements are developed, where the intrinsic characteristics are used to compute a similarity or a distance between the elements. Each element is evaluated based on a set of intrinsic characteristics, like color, size, price, or other properties. Based upon values of the characteristics, similarities or distances between each element are determined. The similarities or distances are used to infer elements belonging to a common group.

Cluster consumers, e.g., consumers of data from the clusters, may express several conditions, other than similarity and distance between the elements. Based upon the conditions attributed to the elements, clusters of the elements may be altered to provide a condition-specific clustering of elements.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a system to cluster a plurality of objects associated with a dataset, according to an embodiment.

FIG. 2 is a flow diagram illustrating process to cluster a plurality of objects associated with a dataset, according to an embodiment.

FIG. 3 is a block diagram illustrating a system to cluster a plurality of objects associated with a dataset, according to an embodiment.

FIG. 4 is a table illustrating a dataset including a plurality of objects for clustering, according to an embodiment.

FIG. 5A-5C are tables illustrating a preference degree generated to cluster a plurality of objects associated with a dataset, according to an embodiment.

FIG. 6 is a table illustrating a relationship matrix generated to cluster a plurality of objects associated with a dataset, according to an embodiment.

FIG. 7 is a table illustrating individual similarity measures generated to cluster a plurality of objects associated with a dataset, according to an embodiment.

FIG. 8 is a table illustrating a similarity measure generated to cluster a plurality of objects associated with a dataset, according to an embodiment.

FIGS. 9A and 9B are block diagrams illustrating clustering of a plurality of objects associated with a dataset, according to an embodiment.

FIG. 10 is a block diagram illustrating an exemplary computer system, according to an embodiment.

### DETAILED DESCRIPTION

Embodiments of techniques to cluster a plurality of objects associated to a dataset are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Clustering of objects helps in determining objects having common characteristics. A clustering framework performs a preference-based clustering by determining preferences information associated with criteria of the objects. In an embodiment, the criteria of the objects are obtained by evaluating the objects. The clustering framework determines a selection of criteria to cluster the objects and the preference information provided to perform a preference-based clustering of the objects. The selection of the criteria and the preference information may be provided by the end user, and thus are subjected to change over time. The criteria and the preference information provided at every instance of time helps in grouping and regrouping the objects according to an end user requirement. Based on the preference information, relationships between the objects are determined. Based on the relationships thus obtained, the objects are grouped or clustered. For example, in an equipment monitoring application, where a selected criteria is ‘maintenance’ and a preference information is ‘minimum’, identifying equipment based on their maintenance and grouping the equipment as high maintenance, low maintenance and medium maintenance is helpful to determine equipment that require minimum maintenance.

Embodiments include a mechanism of representing the obtained clusters, where the clustering framework identifies the relationships. Based on the strength of the relationships, the framework visually represents the obtained clusters.

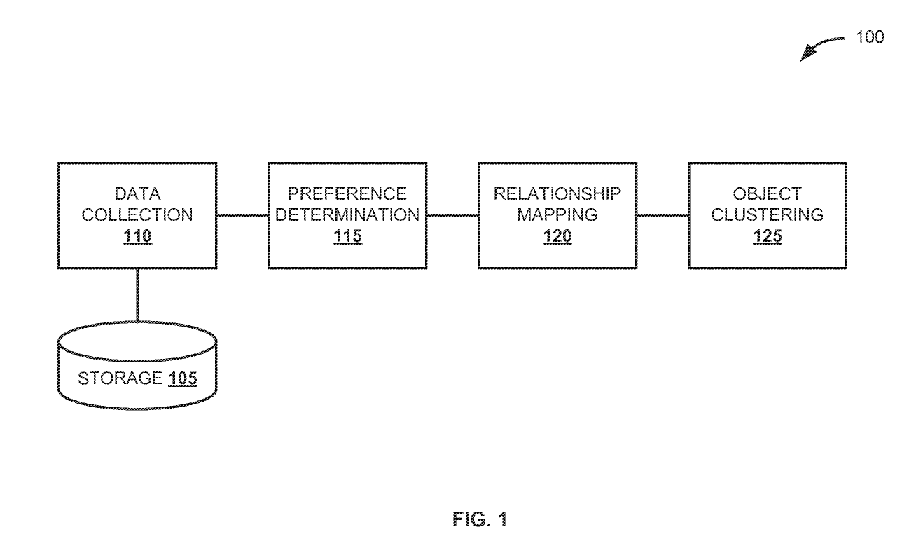

FIG. 1 is a block diagram illustrating a system to cluster a plurality of objects associated with a dataset, according to an embodiment. Clustering a plurality of objects includes grouping the objects based on common factors corresponding to the objects. For instance, in a human resource management application, employees with similar behaviors and similar performances on specified goals may be grouped together; candidate applications may be grouped in various categories depending on their area of expertise, experience level and the like. The factors for clustering the objects may be provided by an end-user who utilizes the clustered objects for decision making.

In an embodiment, a dataset representing the data associated with a business application and/or scenarios (e.g. human resource management application, equipment monitoring application) is provided on a computer generated user interface, for clustering the objects associated with the dataset. To cluster objects associated with the dataset, factors corresponding to the dataset are selected. These factors represent criteria based upon which the objects to be clustered. For the selected criteria, preference information is provided to perform a preference-based clustering. Preference information represents instructions or directions associated with the criteria along with allowable thresholds corresponding to values of the criteria. For instance, in a human resource management application, if a criterion ‘employee performance’ is selected, the preference information may represent ‘maximum’ (i.e. the preference is oriented towards employees with a high performance rating), and a threshold of the ‘employee performance’ may be ‘at least Grade B’.

System 100 may be used to cluster a plurality of objects associated with a dataset. System 100 includes storage 105 configured to store a plurality of datasets corresponding to a plurality of business or system applications, and/or business scenarios. System 100 includes data collection block 110, preference determination block 115, relationship mapping block 120 and object clustering block 125. Data collection block 110 identifies the dataset associated with a corresponding application (or scenario) and renders the dataset to a user interface. Data collection block 110 also identifies and receives the selected criteria and the preference information from the user interface to perform the clustering of objects.

Based upon the selected criteria and the received preference information, a preference degree between the objects is computed. Preference determination block 115 determines the selected criteria and the preference information to compute the preference degree. In an embodiment, preference determination block 115 computes individual preference degrees for each selected criterion and aggregates all the individual preference degrees to compute a universal preference degree.

A relationship map that represents relationships between the objects, according to the preference information may be rendered. Relationship mapping block 120 generates a relationship matrix based on the preference degree. Relationship mapping block 120 determines preference-types associated with the preference information and attributes a value of relationships corresponding to the preference-types. Thus, relationship mapping block 120 renders multi-criteria preference for clustering objects. The relationship matrix includes preference-based similarity measures, which can be used in a network-based algorithm for clustering the objects.

Values in the relationship matrix describe strength of the relationship between corresponding objects. Using the strengths of the relationships between the objects, a similarity pattern may be built, where each node represents an object and each edge represents a relationship between two corresponding nodes. In an embodiment, the similarity pattern represents a graph. Object clustering block 125 may generate the similarity pattern including the nodes and the edges, and assign the edges with values associated with the relationship matrix. Object clustering block 125 may apply clustering mechanism to determine subsets of the nodes having dense connections and subsets of nodes having sparse connections. Based upon the connections, clustering of the objects associated with the dataset is performed. In an embodiment, object clustering block 125 generates a visualization of the clustering using various visualization techniques. In an embodiment, a dense connection represents multiple relations between two corresponding nodes, and a spares connection represents few relations between two corresponding nodes. In an embodiment, “connection” and “relation” are used alternatively.

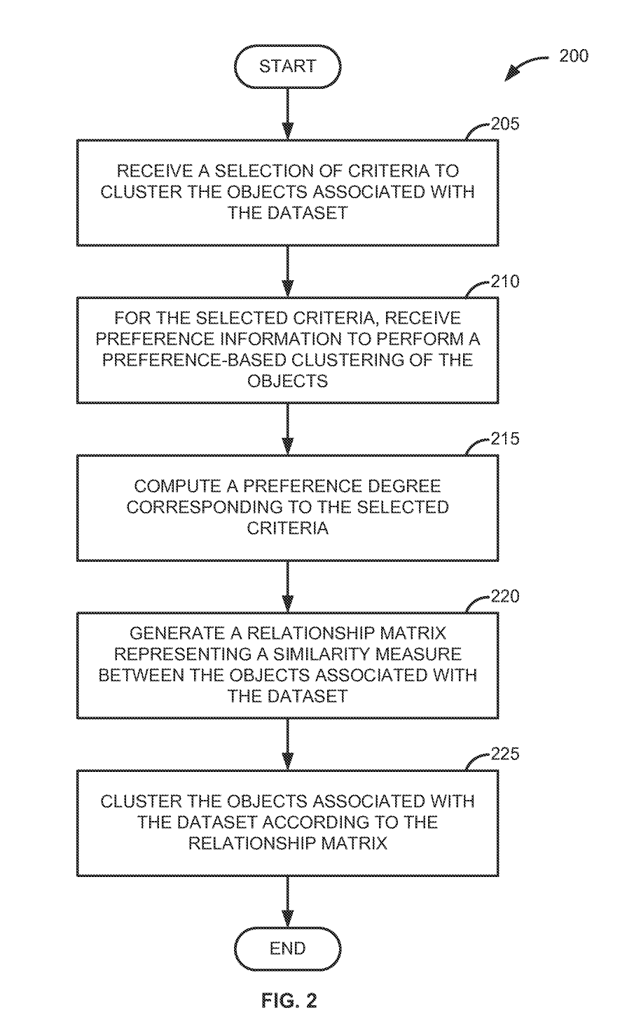

FIG. 2 is a flow diagram illustrating process to cluster a plurality of objects associated with a dataset, according to an embodiment. A dataset associated with an application, e.g. a business application, generally includes objects and their criteria. The dataset also includes values corresponding to the criteria. To establish a decision associated with the application, the objects may have to be clustered based on preferences of a decision maker. In an embodiment, a decision maker is an end-user who utilizes an analysis of the dataset and a visualization of the clusters of objects. In another embodiment, a decision maker is a system that is required to utilize the clusters of objects to complete an associated process.

The objects are clustered based upon the criteria selected and the corresponding preference information provided to complete the process of clustering. At 205, a selection of criteria to cluster the objects associated with a dataset is received. At 210, for the selected criteria, preference information is received to perform a preference-based clustering of the objects. Based upon the selected criteria and the received preference information, at 215, a preference degree is computed. In an embodiment, a uni-criterion preference degree is computed for each criterion selected, and multiple of the uni-criterion preference degrees are aggregated to generate a universal preference degree. The uni-criterion preference degrees corresponding to each criterion represents strength of a preference threshold between the objects. The aggregated universal preference degree represents strength of a global preference threshold between the objects associated with the business application.

Based upon the computed (global) preference degree, at 220, a relationship matrix representing a similarity measure between the objects associated with the dataset is generated. The relationship matrix is generated by determining a preference-type associated with the preference information, determining a preference-type relationship and attributing the matrix with an identifier identifying the preference-type relationship between the corresponding objects. At 225, the objects associated with the dataset are clustered according to the relationship matrix. A preference-based clustering framework executes the above process to cluster a plurality of objects.

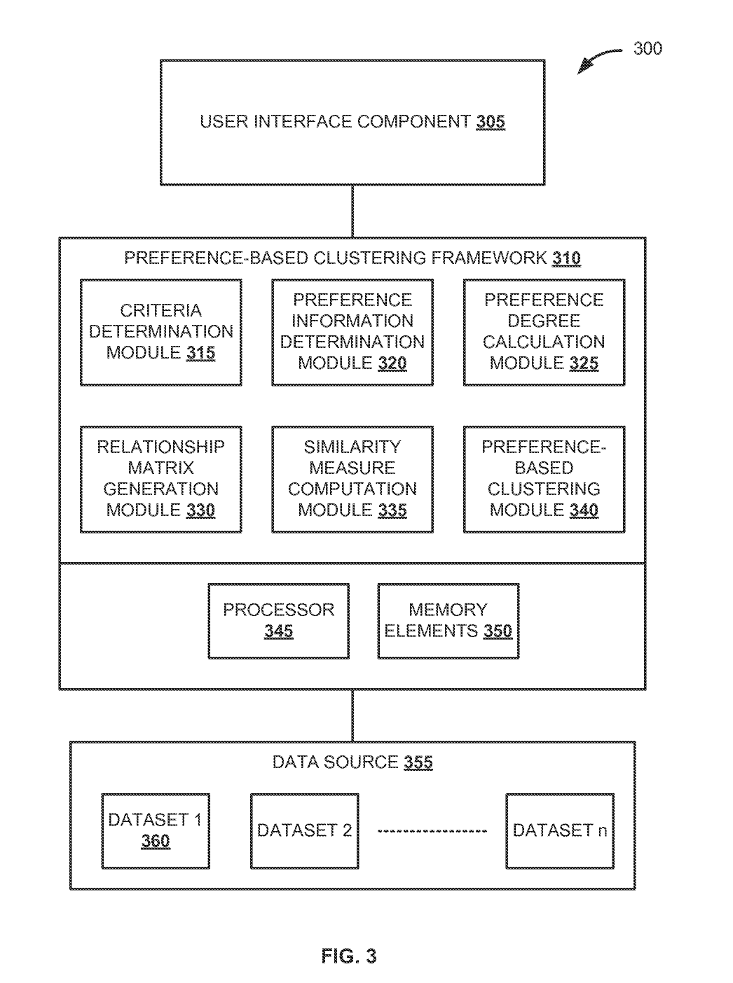

FIG. 3 is a block diagram illustrating a system to cluster a plurality of objects associated a dataset, according to an embodiment. System 300 illustrates a preference-based clustering framework that utilizes criteria and preference information to cluster objects associated with a dataset of an application. System 300 includes user interface (UI) component 305, data source 355 and preference-based clustering framework 310. Preference-based clustering framework 310 includes criteria determination module 315, preference information determination module 320, preference degree calculation module 325, relationship matrix generation module 330, similarity measure computation module 335, preference-based clustering module 340, processor 345 and memory element(s) 350.

User interface component 305 is operable to render a dataset associated with an application on a corresponding UI. UI component 305 is also operable to identify and receive inputs from the UI and render outputs associated with framework 310 on the UI. Data source 355 is operable to store datasets associated with a plurality of applications corresponding to a plurality of business scenarios. Processor 345 associated with framework 310 is operable to determine criteria and preference information provided on the UI, and to retrieve relevant dataset and associated criteria from data source 355. Dataset 360 is an exemplary dataset considered to illustrate a mechanism of clustering a corresponding plurality of objects. Memory element(s) 350 are configured to store instructions to execute the clustering mechanism.

Preference-based clustering framework 310 performs a preference-based clustering of the objects by determining preferences information associated with criteria selected for clustering. A dataset rendered on the UI may include objects and corresponding criteria of a business scenario associated with the dataset. The dataset also includes values corresponding to the criteria. For instance, a dataset associated with a human resource management application includes an arrangement of various objects of the application: EMPLOYEE A, EMPLOYEE B, EMPLOYEE C, EMPLOYEE D, EMPLOYEE E, and EMPLOYEE F; along with criteria: EMPLOYEE PERFORMANCE, EMPLOYEE EXPERTISE LEVEL, EMPLOYEE WORKING and HOURS PER WEEK. Dataset includes values corresponding to the criteria: MEET GOALS, EXCEED GOALS and DOES NOT MEET GOALS for EMPLOYEE PERFORMANCE; BEGINNER, INTERMEDIATE and PROFICIENT for EXPERTISE LEVEL; and number of working hours of each employee for EMPLOYEE WORKING HOURS PER WEEK. A dataset may include an arrangement of such data associated with a business scenario or an application. The following table. Table 1 illustrates an exemplary dataset including the objects, criteria and values in a tabular format. In an embodiment, the criteria represent the criteria of the objects.

TABLE 1

| | | | EMPLOYEE |
|---|---|---|---|
| | EMPLOYEE | EMPLOYEE | WORKING |
| | PERFOR- | EXPERTISE | HOURS |
| | MANCE | LEVEL | PER WEEK |
| EMPLOYEE A | MEET GOALS | BEGINNER | 40 HOURS |
| EMPLOYEE B | MEET GOALS | BEGINNER | 40 HOURS |
| EMPLOYEE C | EXCEED GOALS | BEGINNER | 45 HOURS |
| EMPLOYEE D | DOES NOT | BEGINNER | 30 HOURS |
| | MEET GOALS | | |
| EMPLOYEE E | EXCEED GOALS | INTERME- | 50 HOURS |
| | | DIATE | |
| EMPLOYEE F | EXCEED GOALS | PROFICIENT | 45 HOURS |

Table 1 includes a tabular representation of the dataset associated with an application or a scenario. A decision maker may select one or more criteria based upon which the employees are clustered.

Framework 310 determines a selection of criteria to cluster the objects and the preference information provided to perform a preference-based clustering of the objects. The selection of the criteria and the preference information may be provided by the end user, and thus are subjected to change over time. For example, at a first instance, a decision maker may choose a criterion “EMPLOYEE PERFORMANCE” and provide corresponding preference information “MAXIMUM”. Preference-based clustering framework 310 clusters the objects based upon a “MAXIMUM” value for “EMPLOYEE PERFORMANCE”.

The criteria and the preference information provided at every instance aids in grouping and regrouping the objects according to an end user requirement. Based on the preference information provided at an instance for the criteria, relationships between the objects are determined. Based on the relationships thus obtained, the objects are clustered.

Criteria determination module 315 is operable to determine the criteria selected to perform the clustering of the objects. In an embodiment, based upon the criteria available for the rendered dataset, a decision maker selects one or more criteria based upon which the objects are clustered. The selection of the criteria received on the UI is determined by criteria determination module 315. Criteria determination module 315 is operable to identify the selected criteria and render available preferences to be applied to the clustering, based upon the selected criteria. The available preferences may be rendered on the UI, where the decision maker provides preference information in the form of an input, or selects available preference information associated with the available preferences. Preference information determination module 320 determines the preference information provided by the decision maker. Preference and/or preference information may include preference direction, preference-types, preferred thresholds of values, preferred instance, and the like. For instance, a consumer may select three criteria “TIME”, “PRICE” and “QUALITY”; and specify that “TIME” and “PRICE” of a product need to be “MINIMIZED” and “QUALITY” of the product needs to be “MAXIMIZED”, as the preference information. A sales executive may select the same criteria PRICE and specify that “PRICE” of the product needs to be “MAXIMIZED”, to generate revenue. Further, the decision maker may specify that if a “DIFFERENCE” on the PRICE criterion between two products is “LESS THAN $10”, the two objects are said to be “INDIFFERENT”. Here the “INDIFFERENCE” represents a preference-type and the $10 represents an “INDIFFERENCE” threshold. Similarly, other preference-type include incomparable, preferred to or preferred by relationships

In an embodiment, normalized weights are received as preference information. In another embodiment, an indifference threshold may be received as preference information. The indifference threshold may represent a minimum threshold value, below which the difference of performance between the objects is considered as insignificant. For instance, if $10 is an indifference threshold of price between two objects; there is no preference amongst two objects if the difference is lower than $10. For example, if television A is priced at $340 and television B is priced at $349, a user choosing between the two objects may not have any preference, since the price difference between the two televisions is less than the indifference threshold. Here, the difference in price (which is $9) is considered as insignificant, since the indifference threshold is $10.

In another embodiment, a preference threshold representing a maximum threshold value, above which the difference of performance between objects leads to a strong preference towards an object with a high value on that criterion. For instance, if $20 is a preference threshold of price between two objects: there is a strong preference for a cheaper object when the difference between two objects is greater than $20. For example, if television A is priced at $340, and television B is priced at $365, a user choosing between the two objects prefers television A over television B. In another example, if a sales person's commission of sales is dependent on the cost of the television; the sales person may prefer to recommend television B over television A, while selling the television to a customer.

Such information reflecting a preference of a decision maker may be referred to as preference information. Framework 310 performs a preference-based clustering, by including the preference information provided by the decision maker, to cluster the objects based on the criteria and the preference information provided at that instance. In an embodiment, the mechanism of clustering the objects based upon the criteria and the preference information includes computing a preference degree in order to capture the preference information; generating a relationship matrix representing a similarity measure between the objects; and clustering the objects accordingly. Preference-based clustering framework 310 captures criteria and preference information provided by a decision maker, constructs preference degrees, generates relationship matrix including preference-based similarity measures and clusters the objects.

Preference degree calculation module 325 compares the objects against each other based upon the preference information provided by a decision maker. A preference degree corresponds to a preference of a first object to a second object. Usually a value of this preference degree exists between zero (0) and one (1), where value ‘zero’ indicates that the two corresponding objects are indifferent; and value ‘one’ indicates that there is a strong preference of one object when compared to the other objects. Values occurring between zero and one may indicate that the two corresponding objects include any one of indifferent, incomparable, preferred to or preferred by relationships.

An indifferent relationship may represent a relationship between two indifferent objects, and thus one cannot establish a preference between such indifferent objects. For example, two indifferent objects include EMPLOYEE A and EMPLOYEE B. An incomparable relationship may represent a relationship between two objects having some advantages and disadvantages, but both the objects lack features or characteristics or criteria that can be comparable; and thus a preference between such incomparable objects may not be obtainable. For example, two incomparable objects include MOTHER and FATHER. A preferred relationship may represent a relationship between two objects that have some factors in common. For example, two objects in a preference relationship include a BLUE CAR and a RED CAR. A person A may prefer a BLUE CAR to a RED CAR. A person B may prefer a BLUE CAR by a RED CAR, in other words the user prefers a RED CAR to a BLUE CAR. Hence, a preference relationship includes a preferred-to relationship and a preferred-by relationship.

In an embodiment, preference degrees are not symmetric, resulting in asymmetric relations. This asymmetric relation develops three different situations while comparing two objects. Consider a dataset A, having two objects i and j. The preference degree π for the object ‘i’ in comparison to object ‘j’ produces three different situations, namely:

πᵢⱼ≈πⱼᵢ≈0 situation (1)

wherein, πᵢⱼ represents a preference degree of object ‘i’ over object ‘j’; πⱼᵢ represents a preference degree of object ‘j’ over object ‘i’; and the value ‘0’ represents a null value for the preference degree between object ‘i’ and object ‘j’, signifying that object ‘i’ and object ‘j’ are INDIFFERENT. Hence, the preference of one object over the other is zero (0).

πᵢⱼ≈πⱼᵢ≈0.5 situation (2)

wherein, πᵢⱼ represents a preference degree of object ‘i’ over object ‘j’; πⱼᵢ represents a preference degree of object ‘j’ over object ‘i’; and the value ‘0.5’ represents a 50% preference between object ‘i’ and object ‘j’, signifying that object ‘i’ and object ‘j’ have both good and weak characteristics or criteria. Hence the objects are INCOMPARABLE.

πᵢⱼ>>πⱼᵢ situation (3)

wherein, πᵢⱼ represents a preference degree of object ‘i’ over object ‘j’; πⱼᵢ represents a preference degree of object ‘j’ over object ‘i’. The inequality signs, for e.g. ‘>>’ in situation (3), signify that the preference degree πᵢⱼ must be higher than πⱼᵢ. In situation (3), a preference degree of object ‘i’ is greater than a preference degree of object ‘j’, signifying that object ‘i’ is being PREFERRED TO object ‘j’. In the above case, object ‘j’ is being preferred by object ‘i’. In an embodiment, if object ‘j’ is preferred to object ‘i’, the preference is referred to as ‘PREFERRED BY’.

To derive an equation for each of the three situations, consider the relationships between two objects, based upon the preference degrees. Consider ‘λ’ as a threshold, and a value of ‘λ’ varying between 0<λ<0.5, based upon the above three situations. A relationship ‘P’ between the two objects αᵢ and αⱼ may be derived as:

P_{I}: aⱼP_{I}aⱼ=|πᵢⱼ−πⱼᵢ|<λ and πᵢⱼ<λ equation (1)

wherein, P_{I} represents an INDIFFERENCE relationship between objects αᵢ and αⱼ; an absolute value of a difference between πᵢⱼ and πⱼᵢ is less than λ; and πⱼᵢ individually is also less than λ.

P_{J}: aᵢP_{J}aⱼ [symbol] |πᵢⱼ−πⱼᵢ|<λ and πᵢⱼ>λ equation (2)

wherein, P_{J} represents an INCOMPARABLE relationship between objects αᵢ and αⱼ; an absolute value of a difference between πᵢⱼ and πⱼᵢ is less than λ; and πⱼᵢ individually is greater than λ.

P_{P}+: aᵢP_{P}+aⱼ [symbol] |πᵢⱼ−πⱼᵢ|>λ and πᵢⱼ>λ equation (3a)

wherein, P_{P}_{⁺} represents a PREFERRED TO relationship between objects αᵢ and αⱼ; an absolute value of a difference between πᵢⱼ and πⱼᵢ is greater than λ; and πⱼᵢ individually is greater than λ.

P_{P}: aᵢP_{P}−aⱼ [symbol] |πⱼᵢ−πᵢⱼ|>λ and πⱼᵢ>λ equation (3b)

wherein, P_{P}_{^{−}} represents a PREFERRED BY relationship between objects αᵢ and αⱼ; an absolute value of a difference between πᵢⱼ and πⱼᵢ is greater than λ; and πⱼᵢ individually is greater than λ. The above manner of computation of the preference degree is for a mere illustration. One skilled in the relevant art will recognize, however that the computation of the preference degree can be practiced in various other methods.

Various such relationships may be defined to compute preference degrees between objects. In an embodiment, a universal preference degree is computed as follows: consider a set of criteria F={f₁, f₂, f₃ . . . f_{q}} for evaluating the objects associated with the dataset. The preference information to be received for the selected criteria include: a normalized weight of each criterion ‘wᵢ’; an indifference threshold ‘qᵢ’ that reflects a threshold under which the difference of performances between the objects is considered as insignificant; a preference threshold ‘pᵢ’ that reflects a threshold above which the difference of performances between objects leads to preferring the object with the highest value for the corresponding. Based on the thresholds, a uni-criterion preference degree Pᵢⱼ^{k} is computed. The uni-criterion preference degree Pᵢⱼ^{k} reflects a strength of object aᵢ preferred to object aⱼ, based on criterion fₖ. Pᵢⱼ^{k} is a number comprised between 0 and 1; and may be a function of the difference between the evaluations of the objects, represented as fₖ(aᵢ)-fₖ(aⱼ)). Here, the preference degree may be described as the difference being directly proportional to the difference between the evaluations (e.g. the higher the difference, the stronger the uni-criterion preference degree). The uni-criterion preference degree is derived as:

$${P}_{ij}^{k} = \{ \begin{matrix}0 & if {f}_{k} ( {a}_{i} ) - {f}_{k} ( {a}_{j} ) \leq q \\ [ {f}_{k} ( {a}_{i} ) - {f}_{k} ( {a}_{j} ) - q ] / [ p - q ] & if q < {f}_{k} ( {a}_{i} ) - {f}_{k} ( {a}_{j} ) < p \\ 1 & if {f}_{k} ( {a}_{i} ) - {f}_{k} ( {a}_{j} ) \geq p\end{matrix} \qquad equation ( 4 )$$

wherein, q represents an indifference threshold, and p represents a preference threshold.

Upon computing a uni-criterion preference degree for each criterion selected, all the uni-criterion preference degrees are aggregated into a universal preference degree, signifying a universal comparison between object aᵢ and object aⱼ. The universal preference degree is derived as:

π(αᵢ,αⱼ)=πᵢⱼ=Σₖ₌₁^{q}wⱼ*Pᵢⱼ^{k} equation (5)

Preference degree computation module 325 computes the uni-criterion preference degrees for all the criteria selected, and aggregates the uni-criterion preference degrees into a universal preference degree.

Upon determining the preference comparisons, similarity measure computation module 335 builds a similarity measure in order to streamline the computed values, and capture a universal behavior of a relationship between the objects. In an embodiment, module 335 considers the being PREFERRED TO and the being PREFERRED BY relationships compared to the INDIFFERENT and the INCOMPARABLE relationships. Considering the PREFERRED TO PREFERRED BY, INDIFFERENCE and INCOMPARABLE relationships, a similarity measure is computed as:

$$S ( a , b ) = \frac{{Σ}_{1}^{4} \vert {P}_{i}^{a} ⋂ {P}_{i}^{b} \vert}{\vert A \vert} \qquad equation ( 5 )$$

wherein, Pᵢ^{a}=(x|aPⱼx, ∀xεA) for the relationships P_{I}, P_{J}, P_{P}_{⁺} and P_{P}_{^{−}}. For instance, consider an intersection of P_{P+}^{a} and P_{P+}^{b}, a resultant includes all the elements to which a and b are PREFERRED TO. Consider the intersection set of the elements to which a is preferred and the set to which b is preferred. If two object are identical, then all the relationships to all the elements will be similar and thus the sum of |Pᵢ^{a}∩Pᵢ^{b}|, will be equal to |A|. Substituting the identical objects in equation (5), the similarity measure is S (a, b)=1.

Relationship matrix generation module 330 generates an arrangement resulting from the similarity measures. In an embodiment, relationship matrix generation module 330 generates a relationship matrix based upon the computed preference degrees. In another embodiment, relationship matrix generation module 330 generates a relationship matrix based upon a similarity pattern that is orchestrated as a result of computing the similarity measures for all the objects. To generate the relationship matrix, a preference-type associated with the preference information is determined. A preference-type associated with the preference information represents various relationships between the objects, including the indifferent, incomparable, preferred to, and preferred by relationships. Based upon the preference degrees computed between the objects, a corresponding preference-type relationship is determined. The preference-type relationship describes the relationships according to the actual relationships between any two objects. An identifier indicating the preference-type relationship between the corresponding objects is attributed to the relationship map. The identifier may include a value associated with the object. In an embodiment, relationship matrix generation module 330 computes a preference threshold between the objects for the selected criteria. In another embodiment, relationship matrix generation module 330 computes a preference threshold between the objects based on all criteria associated with the objects. Based upon the corresponding preference information, and the computed preference degree, a preference relationship is determined between all the objects. The similarity measure between all the objects is computed based on the preference thresholds and the preference relationships.

In an embodiment, similarity measure computation module 335 determines the objects corresponding to a preferred-to relationship and the objects corresponding to a preferred-by relationship by examining the associated preference information. The preferred-to and the preferred-by relationships are compared with other preference-type relationships to compute a similarity relationship measure value between each object. Based upon the computed relationship measure value between each object, module 335 generates a similarity pattern including the similarity measure of the plurality of objects associated with the dataset. The value between each object in the similarity pattern indicates the strength of the relationship between the corresponding objects.

In another embodiment, module 335 generates the similarity pattern including a plurality of nodes that represent the objects associated with the dataset, and a plurality of edges representing the preference-type relationship. The edges are attributed with values associated with the relationship matrix. The values in the similarity pattern indicate the strength of the relationship between two objects.

Preference-based clustering module 340 applies a clustering mechanism to determine subsets of the nodes associated with dense connections and subset of nodes associated with sparse connections. A betweenness of the edges is calculated based upon the clustering mechanism. In an embodiment, the betweenness represents a number of shortest paths from all the nodes to all other nodes that pass through a particular edge. An equation representing the betweenness, according to an embodiment, may be derived as:

$$BC ( e ) = {\sum }_{s \neq t ∈ V} \frac{{σ}_{st} ( e )}{{σ}_{st}} \qquad equation ( 6 )$$

wherein, σₛₜ is a total number of shortest paths from node s to node t and σₛₜ(e) is a number of the shortest paths that pass through edge e.

In an embodiment, the betweenness of all existing edges in a network is calculated and an edge with the highest betweenness is removed from a list of the betweenenss of all the edges. The betweenness of all edges affected by the removal is recalculated. The process of calculating and recalculating the betweenness is iteratively performed until all the edges with the highest betweenness are removed. In an embodiment, a betweenness threshold is considered while removing the highest betweenness. Based upon the mechanism of determining the betweenness, the objects are clustered, and a visualization of the clustered objects is rendered on the UI by UI component 305.

In an embodiment, Girvan-Newman's algorithm is applied to determine cluster the objects. In another embodiment, a clustering constant ‘K’ is provided as a betweenness threshold. Based upon the value of K, the betweenness of the existing edges in the network is calculated to cluster the objects. A visualization of the clustered objects is rendered on the UI. In an embodiment, the visualization of the clustered objects includes representing the clustering of the objects as a graphical representation, symbolic representation, spectral representation, chromatic representation, silhouette representation, etc. One skilled in the relevant art will recognize, however that the clustering of objects can be practiced in various other methods.

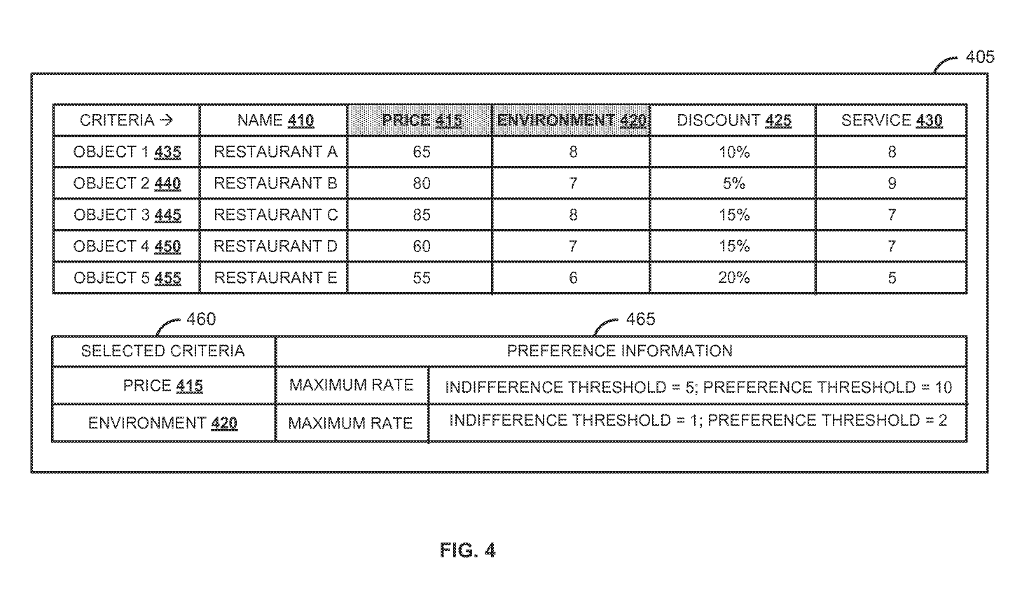

FIG. 4 is a table illustrating a dataset including a plurality of objects for clustering, according to an embodiment. Dataset 405 includes five objects (435, 440, 445, 450 and 455) and five criteria (410, 415, 420, 425 and 430). To cluster the five objects, a selection of two criteria PRICE 415 and ENVIRONMENT 420 is received and identified as selected criteria 460. For the selected criteria preference information 465 is received, indicating that the ENVIRONMENT is preferred to be MAXIMUM with an INDIFFERENCE THRESHOLD value being 1, and PREFERENCE THRESHOLD value being 2; and PRICE is preferred to be MAXIMUM with an INDIFFERENCE THRESHOLD value being 5, and PREFERENCE THRESHOLD value being 10.

The indifference threshold value indicates that a relationship between two objects is indifferent if the difference in the values of the objects is less than 1 for ENVIRONMENT and 5 for PRICE, according to situation (1) and equation (1). Similarly, the preference threshold value indicates that a preference between two objects is established if the difference in the values of the objects is greater than 2 for ENVIRONMENT and 10 for PRICE, according to situation (3) and equation (3).

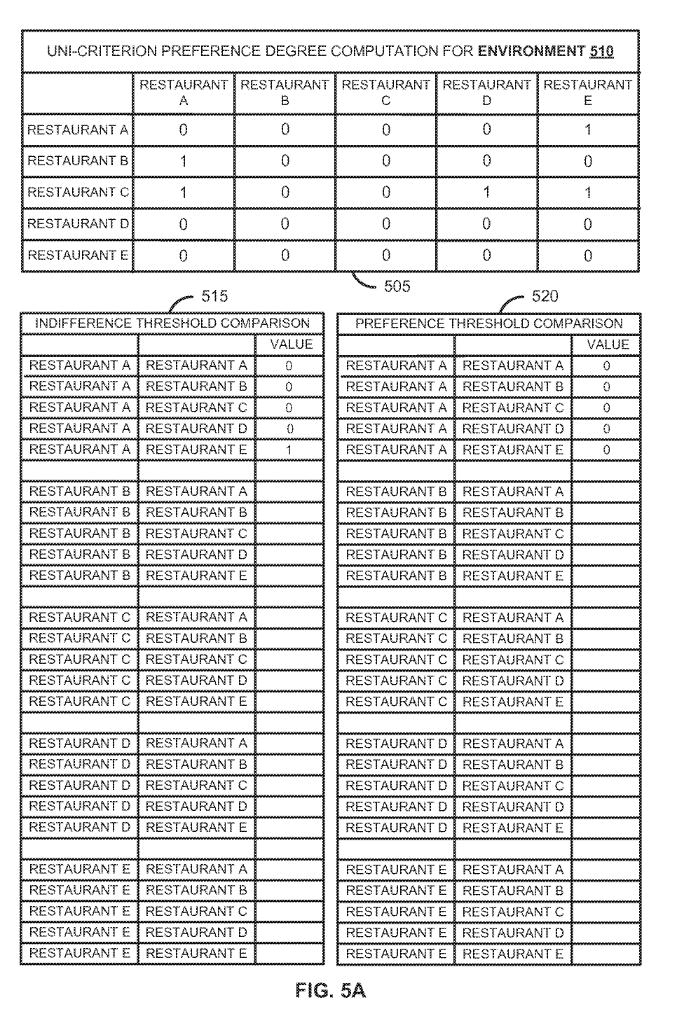

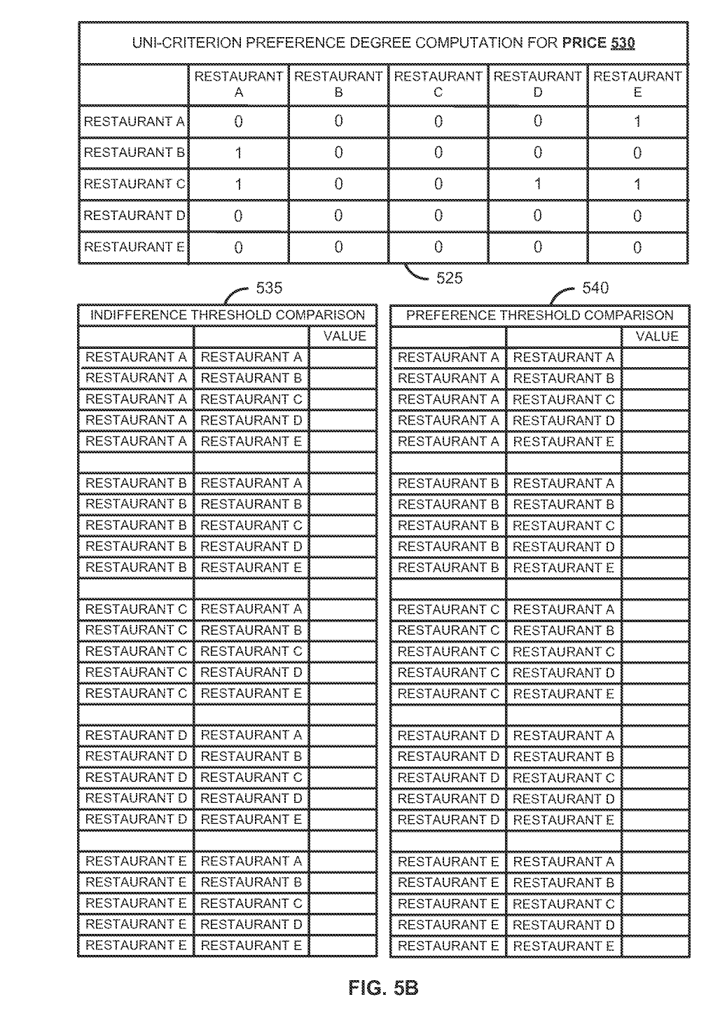

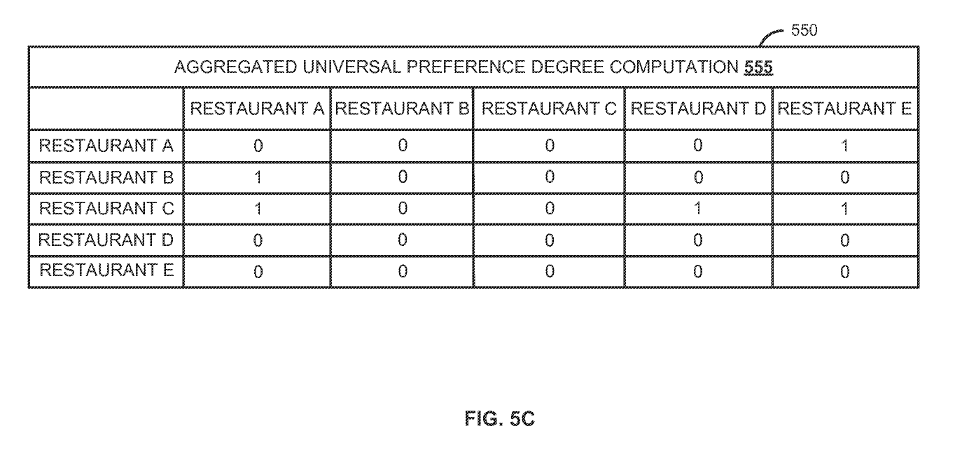

FIG. 5A-5C are tables illustrating a preference degree generated to cluster a plurality of objects associated with a dataset, according to an embodiment. With reference to FIG. 5A, table 505 represents a set of values for uni-criterion preference degrees computed for a first uni-criterion, ENVIRONMENT 510. Table 515 represents a comparison between all the objects based upon the indifference threshold provided in FIG. 4, and table 520 represents a comparison between all the objects based upon the preference threshold provided in FIG. 4.

For instance, based upon the indifference threshold value 1 for environment, when RESTAURANT A's value is compared to RESTAURANT B according to equation (1), the difference in the values is ‘1’, which is equal to the indifference threshold provided in the preference information. Hence, A is indifferent from B. Thus, the entry in the VALUE column of table 515 is ‘0’ indicating that the preference is ‘0’ (since they are indifferent).

In another example, when RESTAURANT A's value is compared to RESTAURANT E according to equation (1), the difference in the values is ‘2’, which is greater than the indifference threshold provided in the preference information. In addition, the indifference threshold between RESTAURANT A and RESTAURANT E is equal to the preference threshold. This implies that there is a preference for one of the two restaurants. Hence, A is not preferred to or preferred by B. Thus, the entry in the corresponding VALUE column of table 520 is ‘0’ indicating that the preference is ‘0’. Similarly, the preference of RESTAURANT B over RESTAURANT A is equal to ‘1’, since the indifference threshold is higher than or equal to the preference threshold. This, the entry in the corresponding VALUE column of table 520 is ‘1’, indicating that the preference is ‘1’.

Upon determining the preference threshold comparison value and the indifference threshold comparison values, table 505 is populated with the corresponding entries.

With reference to FIG. SB, table 525 represents a set of values for uni-criterion preference degrees computed for a second uni-criterion, PRICE 530. Table 535 represents a comparison between all the objects based upon the indifference threshold provided in FIG. 4, and table 540 represents a comparison between all the objects based upon the preference threshold provided in FIG. 4. Upon determining the preference threshold comparison value and the indifference threshold comparison values, table 530 is populated with the corresponding entries.

With reference to FIG. 5C, table 550 represents an aggregated universal preference-degree computation based upon the selected criteria PRICE and ENVIRONMENT and the preference information provided in FIG. 4.

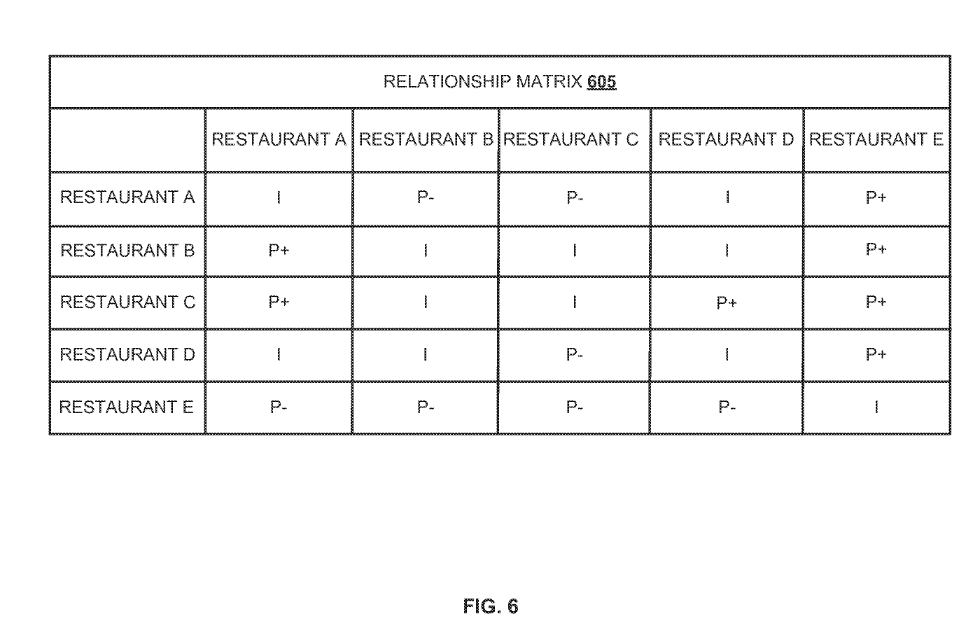

FIG. 6 is a table illustrating a relationship matrix generated to cluster a plurality of objects associated with a dataset, according to an embodiment. Table 605 represents a relationship matrix generated based upon the relationships between the objects, based upon the universal preference degree computation in FIG. 5C. For instance, when an object is compared with itself, e.g. RESTAURANT A with RESTAURANT A, a preference cannot be determined. Hence, the entry in the relationship matrix is 1, signifying INDIFFERENCE relationship. When RESTAURANT A is compared with RESTAURANT B, based upon the preference degree and the preference information, RESTAURANT B is preferred to RESTAURANT A, since the PRICE of B is more than that of A (considering the PRICE criteria to be maximum), and the preference degree computation between A and B alone would yield a preference to B when compared with A. Hence, the entry in the relationship matrix is P⁻, signifying a PREFERRED BY relationship. When RESTAURANT A is compared with RESTAURANT E, based upon the preference degree and the preference information, RESTAURANT A is preferred to RESTAURANT E. Hence, the entry in the relationship matrix is P⁺, signifying a PREFERRED TO relationship.

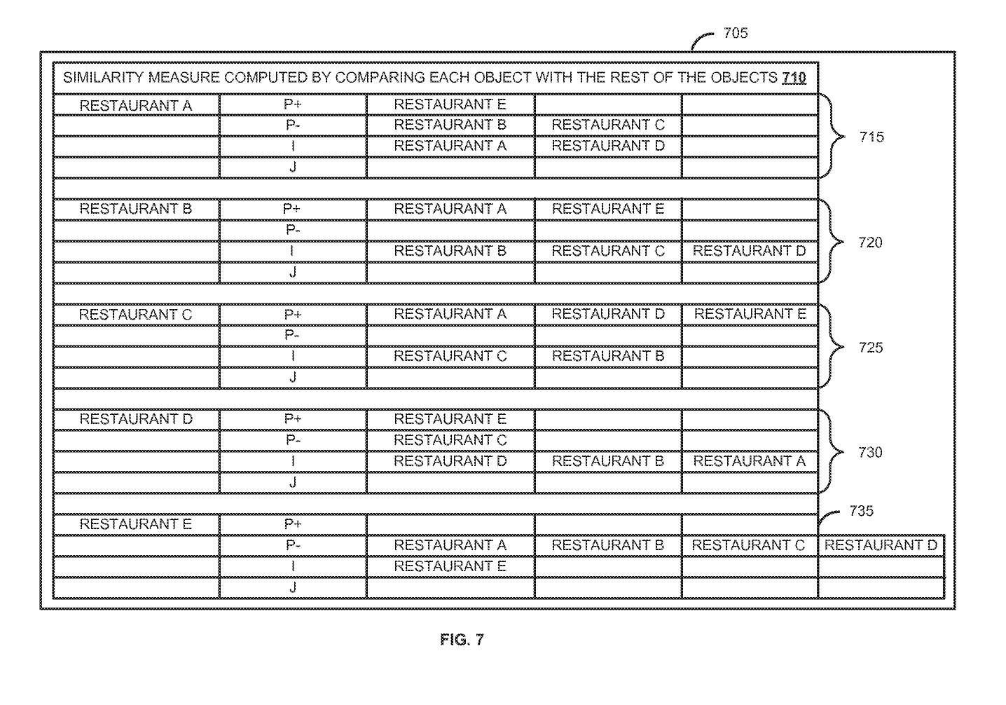

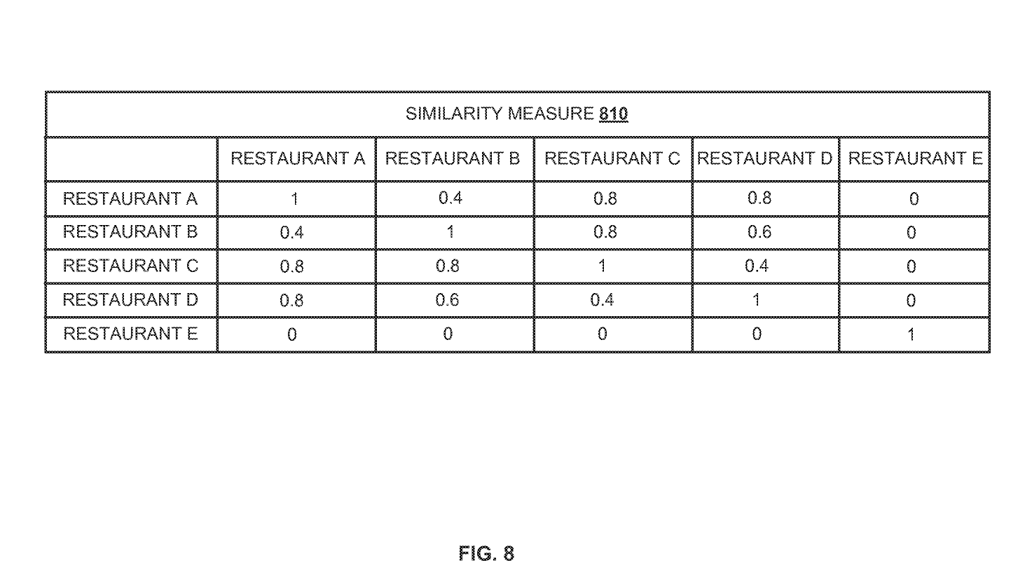

FIG. 7 is a table illustrating individual similarity measures generated to cluster a plurality of objects associated with a dataset, according to an embodiment. Table 705 represents a comparison between the similarity measures of objects associated with the dataset. Similarity measure computation 710 includes a similarity measure comparison between RESTAURANT A and the rest of the restaurants 715 based upon the relationships; between RESTAURANT B and the rest of the restaurants 720 based upon the relationships: between RESTAURANT C and the rest of the restaurants 725 based upon the relationships; between RESTAURANT D and the rest of the restaurants 730 based upon the relationships; and between RESTAURANT E and the rest of the restaurants 735 based upon the relationships. According to table 705, RESTAURANT A and RESTAURANT B have two out of five objects in common; hence, the similarity measure is 40% or 0.4. RESTAURANT B and RESTAURANT C have four out of five elements in common; hence the similarity measure is 80% or 8.0. The similarity measure for a comparison between all the objects are computed and tabulated as show in FIG. 8.

FIG. 8 is a table illustrating a similarity measure generated to cluster a plurality of objects associated with a dataset, according to an embodiment. Upon tabulating the similarity measures, a clustering mechanism is applied to the tabulation, to determine subsets of the nodes associated with dense connections and subset of nodes associated with sparse connections. A betweenness of the edges is calculated based upon the clustering mechanism. In an embodiment, the betweenenss represents a number of shortest paths from all the nodes to all other nodes that pass through a particular edge.

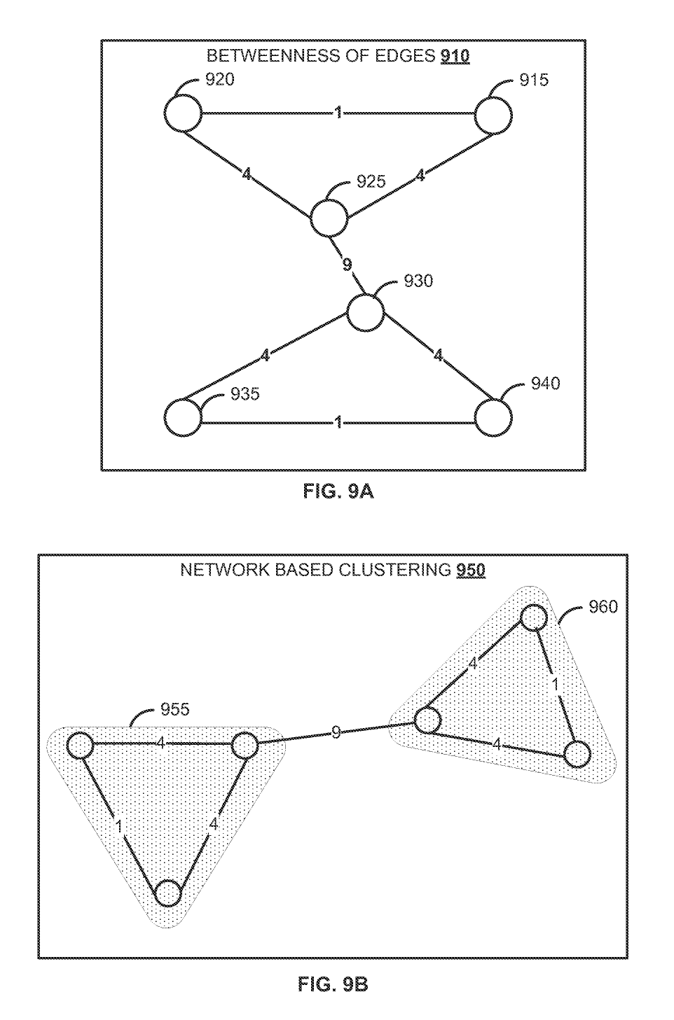

FIGS. 9A and 9B are block diagrams illustrating clustering of a plurality of objects associated with a dataset, according to an embodiment. FIG. 9A illustrates the betweenness of the edges, that is calculated based upon the clustering mechanism. Edges 915, 920, 925, 930, 935 and 940 represent a corresponding relationship between two nodes. The ‘number’ of paths from all the nodes to all other nodes that pass through the corresponding edges 915, 920, 925, 930, 935 and 940 is represented by a numeral on lines connecting the edges. For instance, the line connecting edge 920 and 925 has four (4) paths. FIG. 9B illustrates a visualization of a network based clustering 950 that clusters a plurality of objects associated with a corresponding dataset. Based upon the betweenness of the edges as illustrated in FIG. 9A, the objects are clustered into two clusters, 955 and 960, and the visualization of the clustered objects in the two clusters 955 and 960 are rendered on a user interface.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

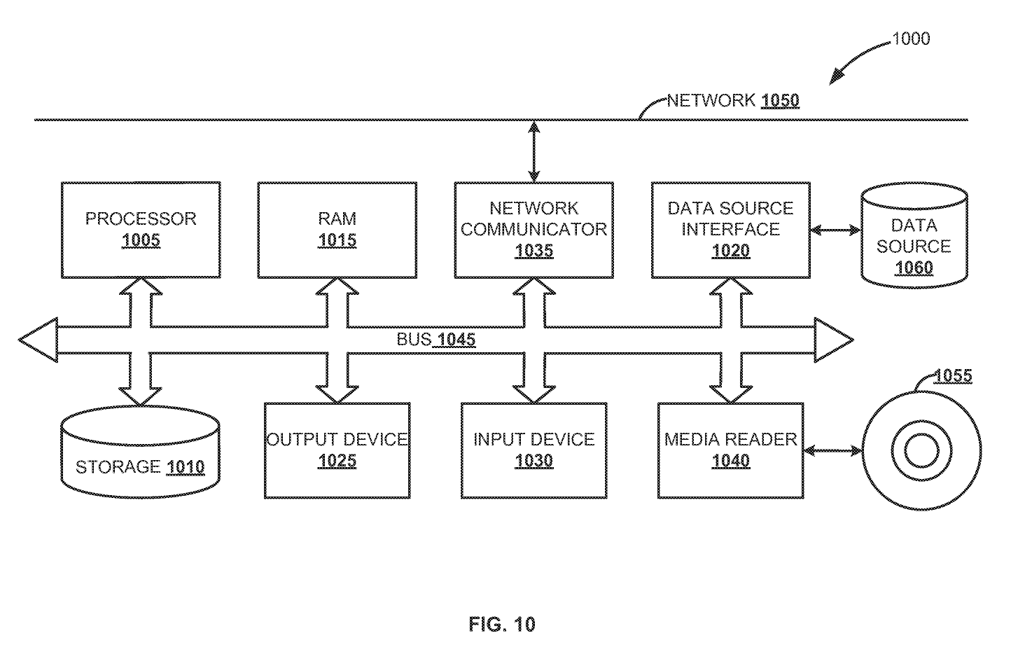

FIG. 10 is a block diagram of an exemplary computer system 1000, according to an embodiment. The computer system 1000 includes a processor 1005 that executes software instructions or code stored on a computer readable storage medium 1055 to perform the above-illustrated methods. The processor 1005 can include a plurality of cores. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. According to some embodiments, such as some in-memory computing system embodiments, the RAM 1015 can have sufficient storage capacity to store much of the data required for processing in the RAM 1015 instead of in the storage 1010. In some embodiments, all of the data required for processing may be stored in the RAM 1015. The stored instructions may be further compiled to generate other representations of the instructions and dynamically stored in the RAM 1015. The processor 1005 reads instructions from the RAM 1015 and performs actions as instructed. According to one embodiment, the computer system 900 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to cluster a plurality of objects associated with a dataset, comprising:
receiving a selection of one or more criteria to cluster the objects associated with the dataset;
for the selected criteria, receiving a preference information to perform a preference-based clustering of the objects;
based on the received preference information, computing a preference degree between the objects corresponding to the selected one or more criteria;
based on the preference degree, generating a relationship matrix representing a similarity measure between the objects associated with the dataset; and
clustering the objects associated with the dataset according to the relationship matrix.

2. The computer implemented method of claim 1 further comprising: generating a framework for clustering the objects associated with the dataset.

3. The computer implemented method of claim 1, wherein receiving the preference information includes:
receiving a normalized weight for the selected criteria;
receiving an indifference threshold; and
receiving a preference.

4. The computer implemented method of claim 1, wherein computing the preference degree includes:
for each of the selected one or more criteria, computing a corresponding uni-criterion preference degree; and
aggregating a plurality of uni-criterion preference degrees associated with the plurality of selected criteria.

5. The computer implemented method of claim 4, wherein a uni-criterion preference degree represents strength of a preference threshold between two or more objects associated with the dataset.

6. The computer implemented method of claim 4, wherein the aggregated plurality of uni-criterion preference degrees represents a universal preference threshold between the objects associated with the dataset.

7. The computer implemented method of claim 1, wherein generating the relationship matrix includes:
determining a preference-type associated with the preference information;
examining the preference degree between the objects, to determine a corresponding preference-type relationship; and
attributing the relationship matrix with a preference-type relationship identifier between the objects corresponding to the preference-type.

8. The computer implemented method of claim 1 further comprising: computing the similarity measure by:
determining the objects corresponding to a preferred-to relationship and a preferred-by relationship, by examining the preference information;
comparing the preferred-to and the preferred-by relationships with one or more preference-type relationships to compute a relationship measure value between the objects; and
based upon the computed relationship measure between each object, generating a similarity pattern including the similarity measure of the plurality of objects associated with the dataset.

9. The computer implemented method of claim 1 further comprising:
generating the similarity pattern including a plurality of nodes representing the objects associated with the dataset, and a plurality of edges representing the preference-type relationship;
attributing the one or more edges with one or more values associated with the relationship matrix; and
applying a clustering mechanism to determine one or more subsets of the nodes associated with dense connections and one or more subsets of nodes associated with sparse connections.

10. The computer implemented method of claim 9, wherein applying the clustering mechanism includes:
calculating betweenness for each of the plurality of edges in a preference network;
removing one or more edges with betweenenss higher than a betweenness threshold, from a list of the betweenenss of the plurality of edges; and
recalculating the betweenness for each of the remaining edges of the plurality of edges.

11. A computer system to cluster a plurality of objects associated with a dataset, comprising:
a processor configured to read and execute instructions stored in one or more memory elements; and
the one or more memory elements storing instructions related to—
receive, from a computer generated user interface, a selection of one or more criteria to cluster the objects associated with the dataset;
for the selected criteria, receive, from a computer generated user interface, preference information to perform a preference-based clustering of the objects;
based on the received preference information, compute a preference degree between the objects corresponding to the selected criteria;
based on the preference degree, generate a relationship matrix representing a similarity measure between the objects associated with the dataset; and
cluster the objects associated with the dataset according to the relationship matrix.

12. The computer system of claim 11, wherein generating the relationship matrix includes:
determining a preference-type associated with the preference information;
examining the preference degree between the objects, to determine a corresponding preference-type relationship; and
attributing the relationship matrix with a preference-type relationship identifier between the objects corresponding to the preference-type.

13. The computer system of claim 11 further comprising instructions related to: compute the similarity measure by:
determining the objects corresponding to a preferred-to relationship and a preferred-by relationship by examining the preference information;
comparing the preferred-to and the preferred-by relationships with one or more preference-type relationships to compute a relationship measure value between the objects; and
based upon the computed relationship measure between each object, generating a similarity pattern including the similarity measure of the plurality of objects associated with the dataset.

14. The computer system of claim 11 further comprising instructions related to:
generate the similarity pattern including a plurality of nodes representing the objects associated with the dataset, and a plurality of edges representing the preference-type relationship;
attribute the one or more edges with one or more values associated with the relationship matrix; and
apply a clustering mechanism to determine one or more subsets of the nodes associated with dense connections and one or more subsets of nodes associated with sparse connections.

15. The computer system of claim 14, wherein applying the clustering mechanism includes:
calculating betweenness for each of the plurality of edges in a preference network;
removing one or more edges with betweenenss higher than a betweenness threshold, from a list of the betweenness of the plurality of edges; and
recalculating the betweenness for each of the remaining edges of the plurality of edges.

16. An article of manufacture including a non-transitory computer readable storage medium to tangibly store instructions, which when executed by a computer, cause the computer to:
receive a selection of one or more criteria to cluster the objects associated with the dataset;
for the selected criteria, receive preference information to perform a preference-based clustering of the objects;
based on the received preference information, compute a preference degree between the objects corresponding to the selected criteria;
based on the preference degree, generate a relationship matrix representing a similarity measure between the objects associated with the dataset; and
cluster the objects associated with the dataset according to the relationship matrix.

17. The article of manufacture of claim 16, wherein generating the relationship matrix includes:
determining a preference-type associated with the preference information;
examining the preference degree between the objects, to determine a corresponding preference-type relationship; and
attributing the relationship matrix with a preference-type relationship identifier between the objects corresponding to the preference-type.

18. The article of manufacture of claim 16 further cause the computer to: compute the similarity measure by:
determining the objects corresponding to a preferred-to relationship and a preferred-by relationship by examining the preference information;
comparing the preferred-to and the preferred-by relationships with one or more preference-type relationships to compute a relationship measure value between the objects; and
based upon the computed relationship measure between each object, generating a similarity pattern including the similarity measure of the plurality of objects associated with the dataset.

19. The article of manufacture of claim 16 further cause the computer to:
generate the similarity pattern including a plurality of nodes representing the objects associated with the dataset, and a plurality of edges representing the preference-type relationship;
attribute the one or more edges with one or more values associated with the relationship matrix; and
apply a clustering mechanism to determine one or more subsets of the nodes associated with dense connections and one or more subsets of nodes associated with sparse connections.

20. The article of manufacture of claim 19, wherein applying the clustering mechanism includes:
calculating betweenness for each of the plurality of edges in a preference network;
removing one or more edges with a betweenenss higher than a betweenness threshold, from a list of the betweenenss of the plurality of edges; and
recalculating the betweenness of the edges affected by the removal for the edges.
